(19) United States
(12) Patent Application Publication
(10) Pub. No.: US 2023/0234614 A1
(43) Pub. Date: Jul. 27, 2023

(54) MOBILE OBJECT CONTROL DEVICE, MOBILE OBJECT CONTROL METHOD, AND STORAGE MEDIUM

(71) Applicant: HONDA MOTOR CO., LTD., Tokyo (JP)

(72) Inventors: Shinsuke Odai, Wako-shi (JP); Kenji Komori, Wako-shi (JP)

(21) Appl. No.: 18/098,739

(22) Filed: Jan. 19, 2023

(30) Foreign Application Priority Data
Jan. 25, 2022 (JP) 2022-009229

(51) Int. Cl. B60W 60/00; B60W 30/095; B60W 40/02

(52) U.S. Cl. CPC B60W 60/0016; B60W 30/0956; B60W 40/02; B60W 2554/80; B60W 2420/42

(57) ABSTRACT

A mobile object control device according to an embodiment includes a recognizer that recognizes a surroundings situation of a mobile object, and an unavoidable contact determiner that determines whether or not contact between the mobile object and an object likely to come into contact with the mobile object is unavoidable on the basis of a recognition result of the recognizer when there is the object around the mobile object, and the unavoidable contact determiner limits a recognition range of the recognizer to a predetermined range including the object when the recognition result of the recognizer satisfies a predetermined condition, and determines whether or not the contact between the mobile object and the object is unavoidable.

### CROSS-REFERENCE TO RELATED APPLICATION

Priority is claimed on Japanese Patent Application No. 2022-009229, filed Jan. 25, 2022, the content of which is incorporated herein by reference.

### BACKGROUND

### Field of the Invention

The present invention relates to a mobile object control device, a mobile object control method, and a storage medium.

### Description of Related Art

In the related art, a technology for recognizing a surroundings situation of a host vehicle to detect contact with an object such as an oncoming vehicle approaching the host vehicle or operate a safety device that protects occupants in preparation for the contact with the object is known (for example, Japanese Unexamined Patent Application, First Publication Nos. 2019-200806, 2016-192164, and 2011-133355).

### SUMMARY

However, when there is a large amount of information such as images, a processing load is increased, and determination processing that requires quickness, such as a contact determination, is likely to take time. Therefore, in some cases, appropriate control of a mobile object cannot be performed.

Aspects of the present invention have been made in consideration of such circumstances, and an object of the present invention is to provide a mobile object control device, a mobile object control method, and a storage medium capable of more appropriately performing mobile object control.

The mobile object control device, the mobile object control method, and the storage medium according to the present invention adopt the following configurations.

(1): A mobile object control device according to an aspect of the present invention is a mobile object control device including: a recognizer configured to recognize a surroundings situation of a mobile object; and an unavoidable contact determiner configured to determine whether or not contact between the mobile object and an object likely to come into contact with the mobile object is unavoidable on the basis of a recognition result of the recognizer when there is the object around the mobile object, wherein the unavoidable contact determiner limits a recognition range of the recognizer to a predetermined range including the object when the recognition result of the recognizer satisfies a predetermined condition, and determines whether or not the contact between the mobile object and the object is unavoidable.

(2): In the aspect (1), the recognizer recognizes the surroundings situation of the mobile object from information including an image captured by an imager, and the unavoidable contact determiner extracts a partial image including the object from the image when the recognition result of the recognizer satisfies the predetermined condition, and uses the extracted partial image to determine whether or not the contact between the mobile object and the object is unavoidable.

(3): In the aspect (2), a size of the partial image is set based on a relative distance between the mobile object and the object.

(4): In the aspect (2), the predetermined condition includes that there is no traffic participant other than the object within a forward viewing angle of the mobile object captured by the imager.

(5): In the aspect (4), the predetermined condition includes that there is no traffic participant within a predetermined range on both sides of a traveling lane of the mobile object, and that there is no object causing a blind spot for the mobile object within the forward viewing angle.

(6): In the aspect (2), the unavoidable contact determiner increases a sampling rate for the determination when determining whether or not the contact between the mobile object and the object is unavoidable using the partial image.

(7): In the aspect (2), when the unavoidable contact determiner determines whether or not the contact between the mobile object and the object is unavoidable using the partial image, the unavoidable contact determiner makes a frame rate of the image captured by the imager higher than a frame rate before the unavoidable contact determination.

(8): In the aspect (1), the mobile object control device further includes: an operation controller configured to operate a protection device configured to protect an occupant of the mobile object when the unavoidable contact determiner determines that the contact between the mobile object and the object is unavoidable.

(9): A mobile object control method according to an aspect of the present invention is a mobile object control method including: recognizing, by a computer, a surroundings situation of a mobile object; determining, by the computer, whether or not contact between the mobile object and an object likely to come into contact with the mobile object is unavoidable on the basis of a recognition result of the surroundings situation when there is the object around the mobile object; and limiting, by the computer, a recognition range to a predetermined range including the object when the recognition result satisfies a predetermined condition, and determining whether or not the contact between the mobile object and the object is unavoidable.

(10): A storage medium according to an aspect of the present invention is a computer-readable non-transitory storage medium having a program therein, the program causing a computer to: recognize a surroundings situation of a mobile object; determine whether or not contact between the mobile object and an object likely to come into contact with the mobile object is unavoidable on the basis of a recognition result of the surroundings situation when there is the object around the mobile object; and limit a recognition range to a predetermined range including the object when the recognition result satisfies a predetermined condition, and determine whether or not the contact between the mobile object and the object is unavoidable.

According to the aspects (1) to (10), it is possible to perform more appropriate mobile object control.

### BRIEF DESCRIPTION OF THE DRAWING

FIG. 1 is a configuration diagram of a vehicle system using a mobile object control device according to an embodiment.

FIG. 2 is a diagram illustrating a contact likelihood determination in a contact likelihood determiner.

FIG. 3 is a diagram illustrating an example of a determination condition table.

FIG. 4 is a diagram illustrating an unavoidable contact determiner.

FIG. 5 is a diagram illustrating prediction of a predicted other-vehicle trajectory based on a limit avoidance operation of another vehicle.

FIG. 6 is a diagram illustrating a difference in a limit avoidance trajectory according to an orientation of wheels.

FIG. 7 is a diagram illustrating extraction of a partial image.

FIG. 8 is a flowchart illustrating an example of a flow of driving control processing that is executed by the vehicle control device;

FIG. 9 is a flowchart illustrating an example of unavoidable contact determination processing.

FIG. 10 is a flowchart illustrating another example of processing that is executed by the vehicle control device.

FIG. 11 is a flowchart illustrating an example of another processing of the unavoidable contact determination processing.

### DESCRIPTION OF EMBODIMENT

Hereinafter, embodiments of a mobile object control device, a mobile object control method, and a storage medium according to the present invention will be described with reference to the drawings. The mobile object control device is a device that controls driving of a mobile object or a device mounted on the mobile object. The “mobile object” refers to a structure that can move using a drive mechanism included in the structure, such as a vehicle, a micro-mobility, an automated mobile robot, a ship, or a drone. In the following description, it is assumed that the mobile object is a vehicle that moves on the ground, and configurations and functions for causing the vehicle to move on the ground exclusively will be described. “Controlling a mobile object” means, for example, mainly performing manual driving with an advice through a driving operation using a voice, display, or the like, or performing interference control to some extent. Controlling the mobile object may include controlling, at least temporarily, one or both of steering and speed of the mobile object to move the mobile object autonomously, or controlling an operation of a protection device for protecting occupants of the mobile object.

### [Overall Configuration]

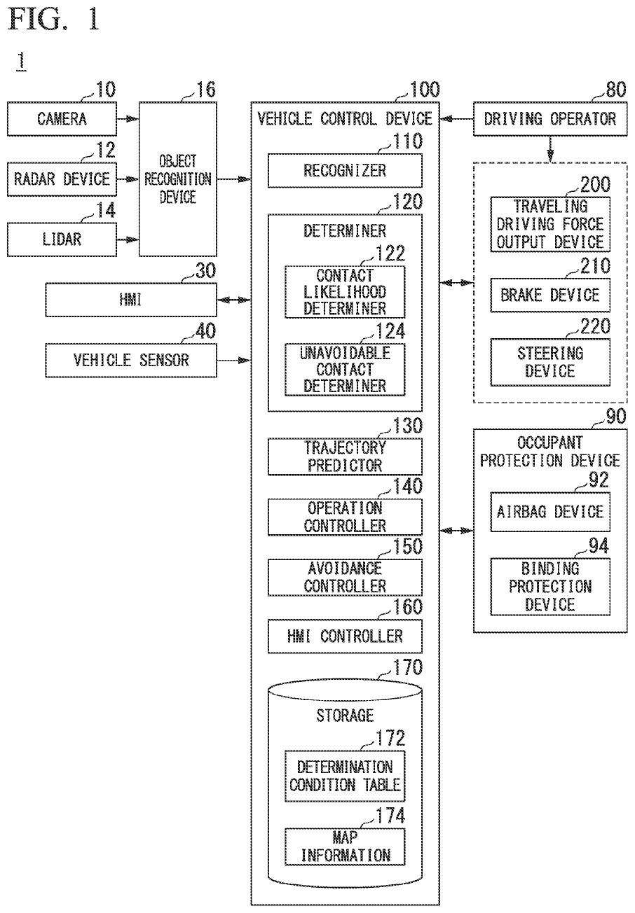

FIG. 1 is a configuration diagram of a vehicle system 1 using a mobile object control device according to an embodiment. A vehicle on which the vehicle system 1 is mounted (hereinafter referred to as a host vehicle M) is, for example, a vehicle such as a two-wheeled vehicle, a three-wheeled vehicle, or a four-wheeled vehicle, and a driving source thereof includes an internal combustion engine such as a diesel engine or a gasoline engine, an electric motor, or a combination thereof. The electric motor operates using power generated by a power generator connected to the internal combustion engine or discharge power of a secondary battery or a fuel cell.

The vehicle system 1 includes, for example, a camera (an example of an imager) 10, a radar device 12, a light detection and ranging (LIDAR) 14, an object recognition device 16, a human machine interface (HMI) 30, a vehicle sensor 40, a driving operator 80, an occupant protection device 90, a vehicle control device 100, a travel driving force output device 200, a brake device 210, and a steering device 220. These devices or equipment are connected to each other by a multiplex communication line such as a controller area network (CAN) communication line, a serial communication line, a wireless communication network, or the like. The configuration illustrated in FIG. 1 is merely an example, and a part of the configuration may be omitted or other configurations may be added thereto. The HMI 30 is an example of an “output device”. The vehicle control device 100 is an example of a “mobile object control device”. The occupant protection device 90 is an example of a “protection device.”

The camera 10 is, for example, a digital camera using a solid-state imaging device such as a charge coupled device (CCD) or a complementary metal oxide semiconductor (CMOS). The camera 10 is attached to any location on the host vehicle M. For example, when a forward side of the host vehicle M is imaged, the camera 10 is attached to, for example, an upper portion of a front windshield, a rear surface of a rearview mirror, or the like. When a backward side of the host vehicle M is imaged, the camera 10 is attached to an upper portion of a rear windshield, a back door, or the like. When a sideward side and a rear sideward side of the host vehicle M are imaged, the camera 10 is attached to a door mirror or the like. The camera 10, for example, periodically and repeatedly images surroundings of the host vehicle M. The camera 10 may be a stereo camera.

The radar device 12 radiates radio waves such as millimeter waves to the surroundings of the host vehicle M and detects radio waves (reflected waves) reflected by an object to detect at least a position (a distance and orientation) of the object. The radar device 12 is attached to any location on the host vehicle M. The radar device 12 may detect a position and speed of the object using a frequency modulated continuous wave (FM-CW) scheme.

The LIDAR 14 irradiates the surroundings of the host vehicle M with light (or an electromagnetic wave with a wavelength close to light) and measures scattered light. The LIDAR 14 detects a distance to a target on the basis of a time from light emission to light reception. The light to be radiated is, for example, pulsed laser light. The LIDAR 14 is attached to any location on the host vehicle M.

The object recognition device 16 performs sensor fusion processing on detection results of some or all of the camera 10, the radar device 12, and the LIDAR 14 to recognize a position, type, speed, and the like of the object. The object recognition device 16 outputs recognition results to the vehicle control device 100. The object recognition device 16 may output detection results of the camera 10, the radar device 12, and the LIDAR 14 as they are to the vehicle control device 100. The object recognition device 16 may be omitted from the vehicle system 1.

The HMI 30 presents various types of information to the occupant of the host vehicle M under the control of the HMI controller 160, and receives input operations from the occupant. Examples of the HMI 30 include any of various display devices, a speaker, a switch, a microphone, a buzzer, a touch panel, and a key. Examples of the various display devices include a liquid crystal display (LCD), and an organic electro luminescence (EL) display device. The display device is provided, for example, near the front of a seat of a driver (a seat closest to a steering wheel) in an instrument panel, and is installed at a position visible to the occupant through a gap in the steering wheel or through the steering wheel. The display device may be installed at a center of the instrument panel. The display device may be a head up display (HUD). The HUD projects an image onto a portion of the front windshield in front of the seat for the driver, thereby allowing eyes of the occupant seated on the seat for the driver to visually recognize a virtual image. The display device displays an image that is generated by the HMI controller 160, which will be described below. The HMI 30 may include, for example, a driving changeover switch that switches between automatic driving and manual driving by the occupant.

The vehicle sensor 40 includes, for example, a vehicle speed sensor that detects a speed of the host vehicle M, an acceleration sensor that detects an acceleration, a yaw rate sensor that detects an angular velocity about a vertical axis, and an orientation sensor that detects an orientation of the host vehicle M. The vehicle sensor 40 may include a steering angle sensor that detects a steering angle of the host vehicle M (which may be an angle of the steered wheel or an operating angle of the steering wheel). The vehicle sensor 40 may include a position sensor that acquires a position of the host vehicle M. The position sensor is, for example, a sensor that acquires position information (longitude and latitude information) from a global positioning system (GPS) device. The position sensor may be, for example, a sensor that acquires position information using a global navigation satellite system (GNSS) receiver of a navigation device (not illustrated) mounted on the host vehicle M.

The driving operator 80 includes, for example, a steering wheel, an accelerator pedal, a brake pedal, a shift lever, and other operators. The operator does not necessarily have to be annular, and may be in the form of a deformed steering wheel, joystick, button, or the like. A sensor for detecting an amount of operation or the presence or absence of the operation is attached to the driving operator 80, and a result of the detection is applied to some or all of the vehicle control device 100, the travel driving force output device 200, the brake device 210, and the steering device 220.

The occupant protection device 90 performs an operation for protecting the occupants inside the vehicle when a predetermined condition such as the host vehicle M coming into contact with another object is satisfied. The occupant protection device 90 includes, for example, an airbag device 92 and a binding protection device 94. The airbag device 92 is an airbag device for a vehicle cabin that reduces a load on occupants in the vehicle cabin when the host vehicle M contacts an object (for example, another vehicle). In the airbag device 92, a high-pressure gas is injected into a bag-shaped chamber housed in a center portion or the steering wheel or the instrument panel in a state in which the chamber is folded before being inflated, for example, under control of an operation controller which will be described below, so that the chamber is inflated and deployed into a predetermined shape from the folded state. Since the inflated and deployed chamber is positioned in front of the occupant, it is possible to mitigate the load on the occupant and protect the occupant at the time of contact with the other object. The airbag device 92 may be an airbag device for a vehicle exterior that reduces a load on not only the occupant in the host vehicle M, but also an object that has come into contact with the host vehicle M by a chamber being inflated and deployed on a bumper portion or a hood of the host vehicle M, instead of (or in addition to) the airbag device for a vehicle cabin.

The binding protection device 94 is, for example, a pretensioner that controls a tension of a seat belt. The seat belt is a belt-shaped safety device that binds a body of the occupant to a seat. For example, the binding protection device 94 has a mechanism for retracting (taking up) the seat belt to remove slack of the seat belt. The pretensioner operates to increase the tension of the seat belt step by step and increase a binding force of the seat belt through driving of a motor under control of the operation controller. The pretensioner is an example of a “tension adjustment mechanism.”

The vehicle control device 100 includes, for example, a recognizer 110, a determiner 120, a trajectory predictor 130, an operation controller 140, an avoidance controller 150, an HMI controller 160, and a storage 170. The recognizer 110, the determiner 120, the trajectory predictor 130, the operation controller 140, the avoidance controller 150, and the HMI controller 160 are realized by a hardware processor such as a central processing unit (CPU) executing a program (software). Some or all of these components may be realized by hardware (circuit; including circuitry) such as a large scale integration (LSI), an application specific integrated circuit (ASIC), a field-programmable gate array (FPGA), or a graphics processing unit (GPU), or may be realized by software and hardware in cooperation. The program may be stored in a storage device (a storage device including a non-transitory storage medium) such as an HDD or a flash memory of the vehicle control device 100 in advance, or may be stored in a detachable storage medium such as a DVD or a CD-ROM and installed in the HDD or the flash memory of the vehicle control device 100 when the storage medium (non-transitory storage medium) is mounted in a drive device. The HMI controller 160 is an example of an “output controller”.

The storage 170 may also be realized by the various storage devices, a solid state drive (SSD), an electrically erasable programmable read only memory (EEPROM), a read only memory (ROM), a random access memory (RAM), or the like. The storage 170 stores, for example, a determination condition table 172, map information 174, programs, and various other information. Details of the determination condition table 172 will be described below. The map information 174 is, for example, information in which a road shape is represented by links indicating a road and nodes connected by the links. The map information 174 may include a road shape (road width, curvature, and gradient), the number of lanes, an intersection, information on a center of a lane, information on lane boundaries (demarcation lines), and the like. The map information 174 may include point of interest (POI) information, traffic regulation information, address information (address and zip code), facility information, telephone number information, and the like.

The recognizer 110 recognizes the surroundings situation of the host vehicle M on the basis of information input from the camera 10, the radar device 12, and the LIDAR 14 via the object recognition device 16. For example, the recognizer 110 recognizes a type, position, speed, acceleration, and the like of an object present around the host vehicle M (within a predetermined distance). Examples of the object include another vehicle, a traffic participant such as a pedestrian or a bicycle, and a road structure. Examples of the road structure include a road signs, a traffic light, a curb, a median, a guardrail, a fence, a wall, and a railroad crossing. The position of the object, for example, is recognized as a position at absolute coordinates with a representative point (a centroid, a drive shaft center, or the like) of the host vehicle M as an origin, and is used for control. The position of the object may be represented by a representative point such as a centroid or a corner of the object or may be represented by an area. The “status” of the object may include an acceleration or jerk of the object, or an “action status” (for example, whether or not the object is changing lanes or is about to change lanes). In the following description, the object is “another vehicle”.

The recognizer 110 recognizes, for example, road demarcation lines (hereinafter referred to as demarcation lines) for demarcating respective lanes included in a road on which the host vehicle M travels, or recognizes a lane in which the host vehicle M travels from the nearest demarcation lines present on the left and right sides of the host vehicle M. The recognizer 110 may recognize the demarcation lines by analyzing the image captured by the camera 10, may refer to the map information 174 from position information of the host vehicle M detected by the vehicle sensor 40 and recognize information on surrounding demarcation lines or traveling lanes from the position of the host vehicle M, or may integrate results of both recognitions.

The recognizer 110 recognizes a position or posture of the host vehicle M with respect to the traveling lane. The recognizer 110 may recognize, for example, a deviation of a reference point of the host vehicle M from a center of the lane, and an angle formed between a traveling direction of the host vehicle M and a line connecting along the center of the lane as a relative position and posture of the host vehicle M with respect to the traveling lane. Instead, the recognizer 110 may recognize, for example, a position of the reference point of the host vehicle M with respect to any one of side end portions (the road demarcation line or the road boundary) of the traveling lane as the relative position of the host vehicle M with respect to the traveling lane.

The recognizer 110 may analyze the image captured by the camera 10, and recognize an orientation of a vehicle body of the other vehicle with respect to a forward direction of the host vehicle M or a direction in which the lane extends, a vehicle width, a position or orientation of wheels of the other vehicle, a wheel base (a distance between a front wheel axle and a rear wheel axle), or the like on the basis of feature information (for example, edge information, color information, and information such as a shape or size of an object) obtained from results of the analysis. The orientation of the vehicle body is, for example, a yaw angle of the other vehicle (an angle of the vehicle body between a traveling direction of the other vehicle and a line connecting a center of the lane). The recognizer 110 may acquire a recognition state of the wheels of the other vehicle (whether or not the wheels are recognized).

The determiner 120 includes, for example, a contact likelihood determiner 122 and an unavoidable contact determiner 124. The contact likelihood determiner 122 determines whether or not there is a likelihood that the host vehicle M and another vehicle will come into contact with each other in the future on the basis of, for example, preset determination conditions according to a state of the other vehicle.

When the contact likelihood determiner 122 determines that there is the likelihood that the host vehicle M and the other vehicle will come into contact with each other in the future, the unavoidable contact determiner 124 determines whether or not the contact between the host vehicle M and another vehicle is unavoidable (whether the contact cannot be avoided) on the basis of predicted trajectories of the host vehicle M and the other vehicle for a certain future period of time in the trajectory predictor 130. Details of the functions of the contact likelihood determiner 122 and the unavoidable contact determiner 124 will be described below.

The trajectory predictor 130 predicts a travel trajectory of the host vehicle M for the certain future period of time (hereinafter referred to as a “predicted host-vehicle trajectory”) on the basis of the position, speed, traveling direction, and the like of the host vehicle M detected by the vehicle sensor 40 and the like. The trajectory predictor 130 predicts a travel trajectory of the other vehicle M for the certain future period of time (hereinafter referred to as a “predicted other-vehicle trajectory”) on the basis of a position, speed, traveling direction, and the like of the other vehicle recognized by the recognizer 110. For example, when the trajectory predictor 130 determines whether the contact between the host vehicle M and the other vehicle is unavoidable, the trajectory predictor 130 predicts the predicted host-vehicle trajectory or the predicted other-vehicle trajectory (a limit avoidance trajectory) in a state of a case in which the host vehicle M or the other vehicle maximizes steering in order to avoid the contact (a limit avoidance operation). These predicted trajectories are, for example, trajectories through which a reference point (for example, a center of gravity or a center) of a target vehicle pass. The trajectory predictor 130 may predict the predicted host-vehicle trajectory and the predicted other-vehicle trajectory when it is assumed that the current speed and traveling direction will continue for a certain period of time.

When the unavoidable contact determiner 124 determines that the contact between the host vehicle M and the other vehicle is unavoidable, the operation controller 140 operates the airbag device 92 and the binding protection device 94 of the occupant protection device 90. The operation controller 140 may operate only the binding protection device 94 or control the chamber inflated and deployed by the airbag device 92, on the basis of the relative speed at the time of contact between the host vehicle M and the other vehicle, a contact position, and the like.

When the contact likelihood determiner 122 determines that there is the likelihood that the host vehicle M and the other vehicle will come into contact with each other in the future, and the unavoidable contact determiner 124 determines that contact between the host vehicle M and the other vehicle is not unavoidable (can be avoided), the avoidance controller 150 controls the brake device 210 to execute control for suddenly stopping the host vehicle M, or controls the travel driving force output device 200 to execute avoidance control such as control for rapidly accelerating the host vehicle M. The avoidance controller 150 may perform avoidance control for controlling the steering device 220 to move the host vehicle M in a direction away from the other vehicle through steering control, instead of (or in addition to) sudden stop or sudden acceleration.

The HMI controller 160 uses the HMI 30 to notify the occupant of predetermined information or acquire information received by the HMI 30 through an operation of the occupant. For example, the predetermined information of which the occupant is notified includes, for example, information related to traveling of the host vehicle M such as information on a state of the host vehicle M or information on driving control. The information on the state of the host vehicle M includes, for example, a speed of the host vehicle M, an engine speed, and a shift position. The information on the driving control includes, for example, information on an operation of the occupant protection device 90 or information on execution of contact avoidance control. The predetermined information may include information for prompting a driving operation for avoiding contact. The predetermined information may include information irrelevant to travel control of the host vehicle M, such as TV programs, and content (for example, movies) stored in a storage medium such as a DVD.

For example, the HMI controller 160 may generate an image including the above-described predetermined information and causes the generated image to be displayed on a display device of the HMI 30 or may generate a voice indicating the predetermined information and cause the generated voice to be output from a speaker of the HMI 30.

The travel driving force output device 200 outputs a travel driving force (torque) for traveling of the vehicle to driving wheels. The travel driving force output device 200 includes, for example, a combination of an internal combustion engine, an electric motor, a transmission, and the like, and an electronic control unit (ECU) that controls these. The ECU controls the above configuration according to information input from the avoidance controller 150 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to the information input from the avoidance controller 150 or the information input from the driving operator 80 so that a brake torque according to a braking operation is output to each wheel. The brake device 210 may include a mechanism that transfers the hydraulic pressure generated by an operation of the brake pedal included in the driving operator 80 to the cylinder via a master cylinder, as a backup. The brake device 210 is not limited to the configuration described above and may be an electronically controlled hydraulic brake device that controls an actuator according to the information input from the avoidance controller 150 and transfers the hydraulic pressure of the master cylinder to the cylinder.

The steering device 220 includes, for example, a steering ECU and an electric motor. The electric motor, for example, changes orientations of steerable wheels by causing a force to act on a rack and pinion mechanism. The steering ECU drives the electric motor according to the information input from the avoidance controller 150 or the information input from the driving operator 80 to change the orientations of the steerable wheels.

### [Functions of Determiner]

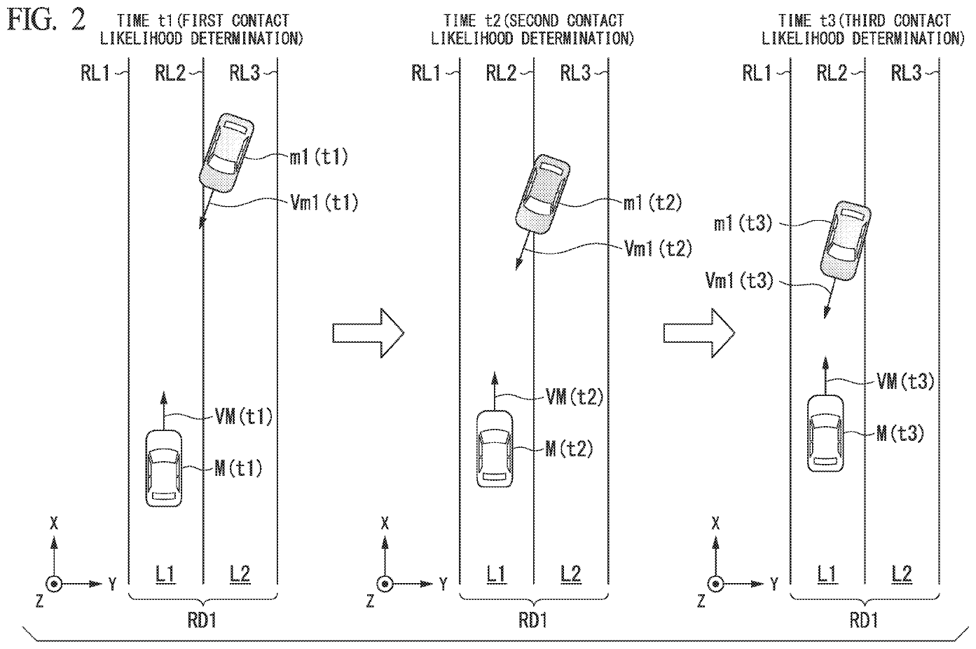

Hereinafter, details of functions of the determiner 120 (the contact likelihood determiner 122 and the unavoidable contact determiner 124) will be described. FIG. 2 is a diagram illustrating a contact likelihood determination in the contact likelihood determiner 122. In an example of FIG. 2, a road RD1 having a lane L1, and a lane L2 that is a lane facing the lane L1 is illustrated. The lane L1 is demarcated by demarcation lines RL1 and RL2, and the lane L2 is demarcated by demarcation lines RL2 and RL3. In the example of FIG. 2, it is assumed that the host vehicle M travels at a speed VM in a direction in which the lane L1 extends (an X-axis direction in FIG. 2), and the other vehicle m1 enters the lane L1 from the lane L2 at a speed Vm1. In the example of FIG. 2, it is assumed that time t1 is the earliest, and time t2 and time t3 are later in that order. In the example of FIG. 2, the position and speed of the host vehicle M at time t* are represented by M(t*) and VM(t*), and the position and speed of the other vehicle m1 are represented by m1(t*) and Vm1(t*).

Under a situation as illustrated in FIG. 2, the recognizer 110 recognizes the position, the speed VM, and the traveling direction (the orientation) of the host vehicle M as the surroundings situation of the host vehicle M, and also recognizes the position, the speed Vm1, and the traveling direction of the other vehicle m1 present in front of the host vehicle M (within a predetermined distance on the forward side). The contact likelihood determiner 122 determines whether or not there is a likelihood of contact between the host vehicle M and the other vehicle m1 on the basis of preset determination conditions (the determination condition table 172). For example, the contact likelihood determiner 122 refers to the determination condition table 172 stored in the storage 170, determines that there is the likelihood of the contact between the host vehicle M and the other vehicle m1 when the determination conditions included in the determination condition table 172 that has been referred to are satisfied, and determines that there is no likelihood of the contact between the host vehicle M and the other vehicle m1 when the determination conditions are not satisfied.

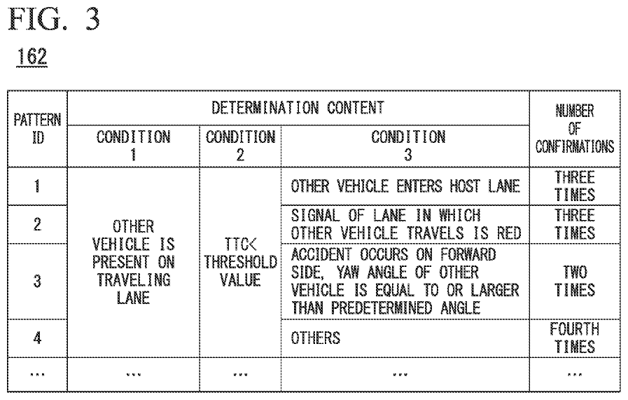

FIG. 3 is a diagram illustrating an example of the determination condition table 172. In the determination condition table 172, for example, determination content and the number of confirmations are associated with a pattern ID that is identification information for identifying a determination pattern. The determination content includes, for example, one or a plurality of determination conditions. In an example of FIG. 3, three determination conditions (conditions 1 to 3) are illustrated. The number of confirmations is the number of times a confirmation is made that the same determination conditions are is satisfied in succession when contact likelihood determination processing (processing for determining whether or not the determination conditions are satisfied) is repeatedly executed at a predetermined cycle. For example, in a case in which the pattern ID in FIG. 3 is “1”, a determination is made that there is a likelihood of contact between the host vehicle M and the other vehicle m1 when the determination conditions 1 to 3 corresponding to the pattern ID of “1” are satisfied three times in succession, and a determination is not made that there is a likelihood of contact when the determination conditions 1 to 3 are satisfied only once or twice. The determination conditions or the number of confirmations are not limited to the example illustrated in FIG. 3, and may be changed depending on a vehicle type or the number of occupants of the host vehicle M, a road situation (a road shape or a surrounding weather), or the like, or may be changed arbitrarily on the manufacturer side.

The contact likelihood determiner 122 determines whether or not the conditions are satisfied for each determination pattern, as shown in FIG. 3, and determines that there is a likelihood that the host vehicle M and the other vehicle m1 will come into contact with each other in the future when a state in which the same conditions are satisfied can be confirmed in succession by the number of times set as the number of confirmations through repetition processing.

The description will be given in detail with reference to FIGS. 2 and 3, and the contact likelihood determiner 122 first determines, as condition 1, whether or not the other vehicle m1 is present on the traveling lane L1 of the host vehicle M. When the contact likelihood determiner 122 determines that the other vehicle m1 is present on the traveling lane L1 of the host vehicle M, the contact likelihood determiner 122 derives a contact margin time TTC (Time To Collision), as Condition 2, using a relative position (a relative distance) and a relative velocity between the host vehicle M and the other vehicle m1 traveling on the lane L2, and determines whether or not the derived contact margin time TTC is smaller than a threshold value. The contact margin time TTC is, for example, a value that is calculated by dividing the relative distance by the relative speed. The threshold value in this case is, for example, about 1.0 to 2.0 [s], but may be variably set depending on the speed VM of the host vehicle M, the speed Vm1 of the other vehicle m1, a road situation, and the like.

When the contact margin time TTC is smaller than the threshold value, the contact likelihood determiner 122 determines whether or not at least any one of the conditions of the respective determination patterns is satisfied as Condition 3. For example, the contact likelihood determiner 122 determines whether the conditions are satisfied in order from “1” to “4” of the pattern IDs. Further, the contact likelihood determiner 122 may determine whether or not the conditions are satisfied in an order of the IDs, and not perform a subsequent determination as to the conditions of the IDs when the conditions are satisfied.

It is assumed that at time t1 in FIG. 2, the contact likelihood determiner 122 determines that conditions 1 to 3 of the pattern ID “1” are satisfied. In this case, the contact likelihood determiner 122 sets the number of confirmations to 1, and performs the determination processing again in the next cycle (time t2).

It is assumed that at time t2, the contact likelihood determiner 122 performs the same determination as that at time t1, and determines that the condition of pattern ID “1” shown in FIG. 3 is satisfied. In this case, the contact likelihood determiner 122 sets the number of confirmations to two and performs the determination processing again in the next cycle (time t3).

It is assumed that at time t3, the contact likelihood determiner 122 has performed the same determination as that at time t1, and determined that the conditions of pattern ID “1” shown in FIG. 3 are satisfied. In this case, since the contact likelihood determiner 122 sets the number of confirmations to three and can confirm a state in which the conditions are satisfied, three times in succession, the contact likelihood determiner 122 determines that there is a likelihood of contact between the host vehicle M and the other vehicle m1 at time t3. When the contact likelihood determiner 122 determines that there is a likelihood of contact, the unavoidable contact determiner 124 determines whether or not the contact between the host vehicle M and the other vehicle m1 is unavoidable.

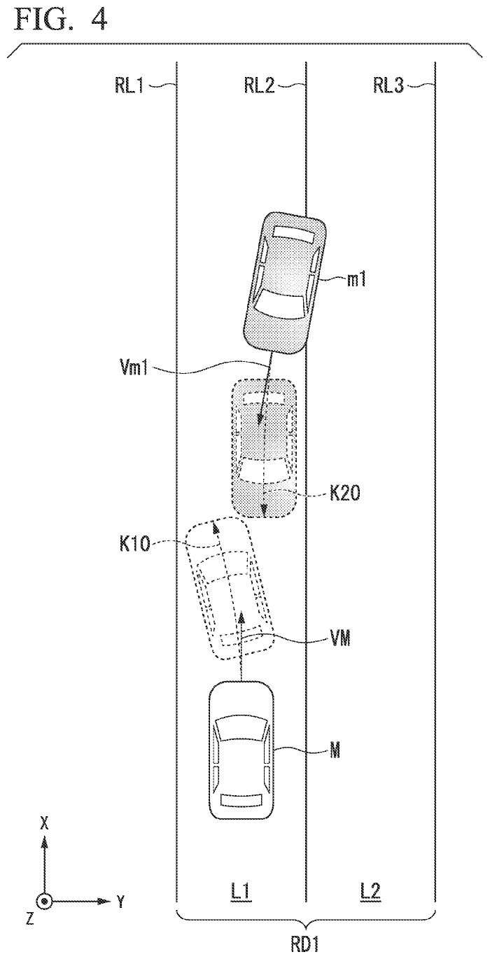

FIG. 4 is a diagram illustrating the unavoidable contact determiner 124. In a case in which it is assumed that the host vehicle M and the other vehicle m1 have each performed the limit avoidance operation from a current position, for example, the unavoidable contact determiner 124 determines that the contact is unavoidable when it is predicted that the host vehicle M and the other vehicle m1 will come into contact with each other in the future, and determines that the contact is not unavoidable when it is predicted that the host vehicle M and the other vehicle m1 will not come into contact with each other due to the limit avoidance operation. The limit avoidance operation is, for example, an operation for increasing a steering angle to a limit value in a direction in which the host vehicle M and the other vehicle m1 separate from each other from a current point in time. The unavoidable contact determiner 124 causes the trajectory predictor 130 to predict the predicted host-vehicle trajectory and the predicted other-vehicle trajectory based on the limit avoidance operation.

The unavoidable contact determiner 124 acquires a predicted host-vehicle trajectory K10 and a predicted other-vehicle trajectory K20 that has been predicted by the trajectory predictor 130, sets an offset area of the respective predicted trajectories K10 and K20 offset depending on a vehicle width in a lateral direction of the vehicle, and determines that the contact between the host vehicle M and the other vehicle m1 is unavoidable when a determination is made that the set offset areas will come into contact (overlap on the trajectories) in the future.

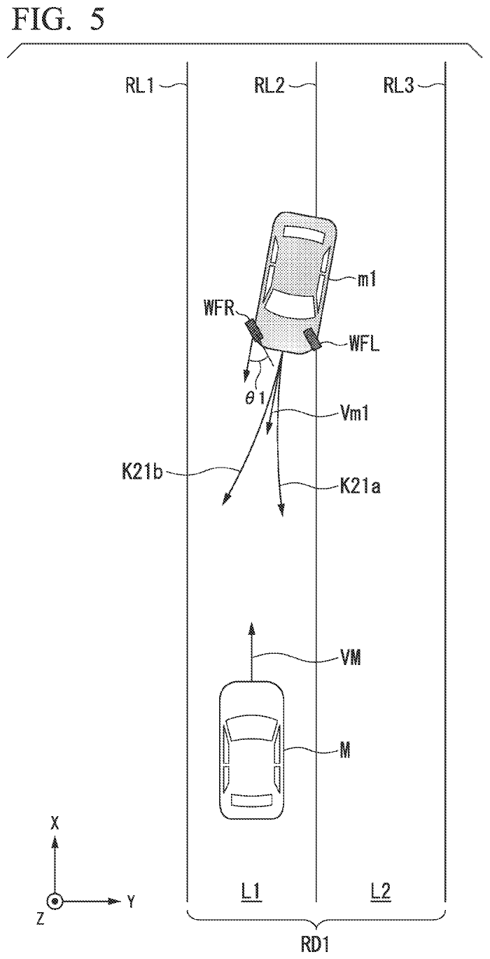

The trajectory predictor 130 may perform limit avoidance prediction depending on whether or not an orientation of a wheel of the other vehicle m1 can be recognized when the trajectory predictor 130 predicts the predicted other-vehicle trajectory on the basis of the limit avoidance operation of the other vehicle m1. FIG. 5 is a diagram illustrating the prediction of the predicted other-vehicle trajectory based on the limit avoidance operation of the other vehicle m1. For example, when a predicted other-vehicle trajectory limit avoidance trajectory based on the limit avoidance operation is predicted from a current orientation of a vehicle body of the other vehicle m1, two limit avoidance trajectories K21a and K21b when the vehicle is steered to left and right to a maximum with respect to a current trajectory at the time of straight traveling are derived, and therefore, it becomes necessary to perform the unavoidable contact determination on the respective trajectories, the processing load increases, and an accurate unavoidable contact determination cannot be performed in some cases.

Therefore, the trajectory predictor 130 predicts the predicted other-vehicle trajectory (limit avoidance trajectory) using different methods (scheme) depending on a case in which an orientation (steering angle) of a wheel (an example of a traveling wheel) of the other vehicle m1 can be recognized and a case in which the orientation cannot be recognized. A wheel that is a recognition target is a wheel whose orientation can be changed among wheels provided in the other vehicle m1. For example, when the recognizer 110 cannot recognize the orientation of the wheel of the other vehicle m1, the trajectory predictor 130 predicts, as the limit avoidance trajectory, a turning trajectory in a case in which it is assumed that the limit avoidance operation (a maximum steering operation) has been performed from a current position and orientation of the vehicle.

When the recognizer 110 can recognize the wheel (at least one of front wheels WFR and WFL) of the other vehicle m1, the trajectory predictor 130 derives the angle θ1 of the wheel with respect to a forward direction of the other vehicle m1, and predicts the limit avoidance trajectory on the basis of the calculated angle θ1.

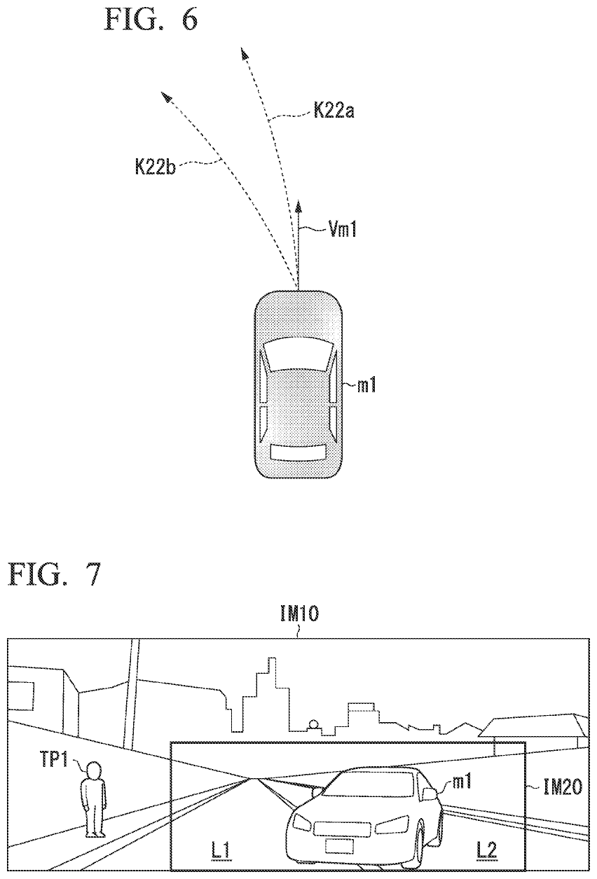

FIG. 6 is a diagram illustrating a difference in the limit avoidance trajectory according to the orientation of the wheel. For example, when the angle θ1 of the wheel is smaller than a predetermined angle θth, the unavoidable contact determiner 124 makes a limit avoidance trajectory via a trajectory along a clothoid curve before the other vehicle m1 enters a turning operation. The clothoid curve is, for example, a curve whose curvature increases on the basis of a constant proportional constant. Therefore, since a limit avoidance trajectory K22a when the angle θ1 of the wheel is smaller than the predetermined angle θth includes a trajectory along the clothoid curve, a range in which avoidance travel is possible is narrower than that for a limit avoidance trajectory K22b when the angle θ1 is equal to or greater than the predetermined angle θth. Thus, the limit avoidance trajectory is derived on the basis of the orientation of the wheels, making it possible to ascertain the limit avoidance trajectory of the other vehicle m1 more accurately, and determine whether the contact between the host vehicle M and the other vehicle m1 is unavoidable more accurately.

The trajectory predictor 130 may predict the limit avoidance trajectory on the basis of a shape of a road around the host vehicle M, a friction coefficient μ between the wheels and a road surface, the wheel base of the other vehicle m1 (the distance between the front wheel axle and the rear wheel axle), and the like, instead of (or in addition to) the angle of the wheel.

The unavoidable contact determiner 124 may change a recognition range of the recognizer 110 around the host vehicle M when predetermined conditions are satisfied, to reduce the processing load and perform the unavoidable contact determination more quickly when performing the unavoidable contact determination between the host vehicle M and the other vehicle m1. For example, in a case in which there is no object that is likely to come into contact with the host vehicle M, other than the other vehicle that is a target for which a determination as to whether or not the contact with the host vehicle M is unavoidable is performed, on the basis of the recognition result of the recognizer 110, the unavoidable contact determiner 124 limits the recognition range of the recognizer 110 to a predetermined range including the other vehicle m1 that is likely to come into contact with the host vehicle M, and determines whether or not the contact between the host vehicle M and the other vehicle m1 is unavoidable. Examples of the case in which there is no object that is likely to come into contact with the host vehicle M may include a case in which an object cannot be recognized by the recognizer 110, and a case in which an object is recognized but a distance between the host vehicle M and the object is equal to or larger than a predetermined distance. Limiting the recognition range means, for example, extracting a partial image of a predetermined area including the other vehicle m1 from an entire area of the image captured by the camera 10.

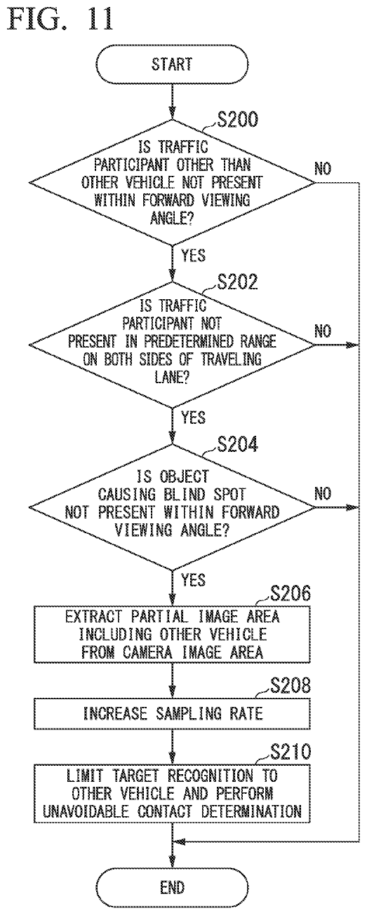

FIG. 7 is a diagram illustrating the extraction of the partial image. In the example of FIG. 7, in the example of FIG. 11, an image IM10 captured by the camera 10 before the unavoidable contact determination is illustrated. The image IM10 includes the lane L1 in which the host vehicle M travels, the other vehicle m1 that approaches the host vehicle M from the facing lane L2 side, and a pedestrian TP1 that stops on a shoulder of a road. The pedestrian TP1 is assumed to be stationary at a place separated from the host vehicle M by a predetermined distance or more.

In the example of FIG. 7, the unavoidable contact determiner 124 extracts a partial image IM20 including the other vehicle m1 from the image IM10. A size of the partial image may be set according to the relative distance between the host vehicle M and the other vehicle m1. In this case, for example, when the relative distance becomes longer, an area decreases, and when the relative distance becomes shorter, the area increases. A size of an area of the partial image may be set, for example, according to a speed, distance, moving direction, road situation, or type of the other vehicle m1. This use of the partial image makes it possible to reduce the processing load and perform the unavoidable contact determination between the host vehicle M and the other vehicle m1 more quickly.

The unavoidable contact determiner 124 may increase a sampling rate of recognition processing or determination processing (the number of times of processing to be executed for a predetermined time) because the partial image is used to reduce the processing load as compared to performing an object determination on the entire image captured by the camera 10. This makes it possible to perform a more detailed determination in an important situation as to whether or not the contact between the host vehicle M and the other vehicle m1 is unavoidable while suppressing a processing load.

The unavoidable contact determiner 124 may adjust a frame rate (fps; frames per second) of time-series image frames captured by the camera 10 to be higher than a frame rate before the unavoidable contact determination when the unavoidable contact determiner 124 extracts the partial image and performs the contact unavoidable determination between the host vehicle M and the other vehicle m1. In this case, for example, in the contact likelihood determination processing (an example of processing before unavoidable contact determination) in the contact likelihood determiner 122, the determiner 120 thins out the time-series image frames captured by the camera 10 at predetermined intervals and performs processing using an image having a first frame rate lower than a threshold value, and in the unavoidable contact determination using the partial image in the unavoidable contact determiner 124, the determiner 120 extracts a partial image having a second frame rate equal to or higher than the threshold value (that is, second frame rate>first frame rate) from the time-series image frames captured by the camera 10 and performs processing. Thus, detailed analysis is performed using a partial image in which the frame rate is made low in processing that uses an entire area of a camera image captured by the camera 10, and the frame rate is made high in a scene in which it is important whether the contact between the host vehicle M and the other vehicle m1 is unavoidable, making it possible to perform a quicker and more detailed determination while suppressing the processing load.

The operation controller 140 operates the occupant protection device 90 when the unavoidable contact determiner 124 determines that the contact of the host vehicle M with the other vehicle m1 is unavoidable. Accordingly, the chamber of the airbag device 92 is inflated and deployed, and a binding force of the seat belt with respect to the occupant is made stronger than usual, so that impact on the occupant at the time of contact is mitigated. Accordingly, since the number of consecutive confirmations changes depending on the contact likelihood determination pattern, it is possible to suppress malfunction of the occupant protection device 90 and protect the occupants more appropriately even when erroneous detection is caused by inaccuracy or error of a sensor.

When the unavoidable contact determiner 124 determines that contact is not unavoidable, the avoidance controller 150 performs avoidance control for avoiding the contact between the host vehicle M and the other vehicle m1. This makes it possible to execute more appropriate driving control according to a situation. When the unavoidable contact determiner 124 determines that the contact of the host vehicle M with the other vehicle m1 is unavoidable, the vehicle control device 100 may perform both the operation control of the operation controller 140 and the avoidance control of the avoidance controller 150. This makes it possible to protect the occupant more safely.

For example, the HMI controller 160 may cause the HMI 30 to output a warning sound or cause the HMI 30 to output information for prompting the occupant to perform a driving operation for avoiding the contact in a state in which the determination conditions in the determination pattern of the contact likelihood determiner 122 are satisfied but the number of consecutive confirmations does not satisfy a determined number of times. The HMI controller 160 may cause the HMI 30 to output a determination pattern in which the determination is made that there is a likelihood of contact.

### [Processing Flow]

Next, a flow of processing that is executed by the vehicle control device 100 of the embodiment will be described. Hereinafter, processing of a determination of the likelihood of contact between the host vehicle M and the other vehicle, a determination of unavoidable contact, and vehicle control based on a determination result (control of the operation of the occupant protection device 90, and the avoidance) among the processing that is executed by the vehicle control device 100 will be mainly described. The processing of this flowchart may be repeatedly executed at predetermined timings, for example.

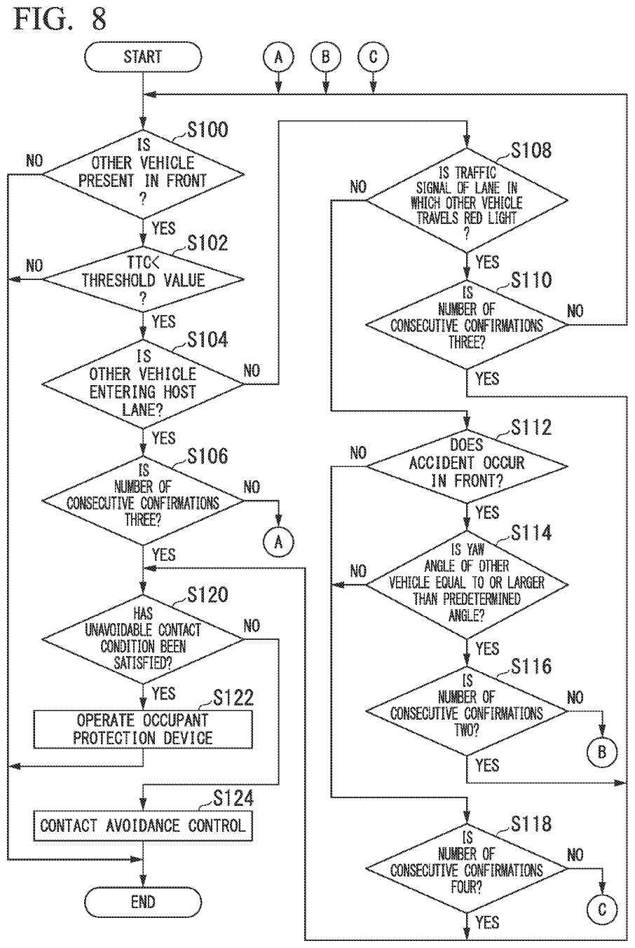

FIG. 8 is a flowchart illustrating an example of a flow of driving control processing that is executed by the vehicle control device 100. In the example of FIG. 8, the contact likelihood determiner 122 determines whether or not the other vehicle m1 is present in front of the host vehicle M (within a predetermined distance) on the basis of the recognition result of the recognizer 110 (step S100)). When a determination is made that the other vehicle m1 is present in front of the host vehicle M, the contact likelihood determiner 122 determines whether or not the contact margin time TTC between the host vehicle M and the other vehicle is smaller than the threshold value (step S102). When a determination is made that the contact margin time TTC is smaller than the threshold value, the contact likelihood determiner 122 determines whether or not the other vehicle m1 is entering a host lane (a lane in which the host vehicle M travels) (step S104). When a determination is made that the vehicle is entering the host lane, the contact likelihood determiner 122 determines whether or not the number of consecutive confirmations is three (step S106). When a determination is made that the number of consecutive confirmations is not three, the processing returns to step S100.

When a determination is made in the processing of step S104 that the other vehicle m1 is not entering the host lane, the contact likelihood determiner 122 determines whether a traffic signal (a traffic light) of a lane in which the other vehicle m1 travels is a red light (step S108). In the processing of step S108, the contact likelihood determiner 122 determines that the traffic light in the lane in which the other vehicle m1 travels is the red light, for example, in a state in which the host vehicle M travels on the host lane toward an intersection and the other vehicle m1 travels on a lane intersecting the host lane toward the intersection and when a traffic light near the intersection of the host lane is a green signal, on the basis of the recognition result of the recognizer 110. The contact likelihood determiner 122 may determine that the traffic light in the lane in which the other vehicle m1 travels (the facing lane) is the red light when the other vehicle m1 is traveling on the facing lane side of the host vehicle M and a traffic light on a traveling lane between the host vehicle M and the other vehicle m1 is a red light. When a determination is made that the traffic light in the lane in which the other vehicle m1 travels is the red light, the contact likelihood determiner 122 determines whether or not the number of consecutive confirmations is three (step S110). When the number of consecutive confirmations is not three, the processing returns to step S100.

When a determination is made in the processing of step S108 that the traffic light in the lane in which the other vehicle m1 travels is not a red light, the contact likelihood determiner 122 determines whether an accident occurs in front of the host vehicle M (within a predetermined distance) (for example, step S112). Examples of the accident include contact between other vehicles, contact between the other vehicle and a road structure, and traveling in a state in which smoke comes from the other vehicle. In the embodiment, a feature quantity of the image is stored in the storage 170 or the like for each predetermined accident (not illustrated), and the contact likelihood determiner 122 compares a feature quantity obtained from the image captured by the camera 10 with a feature quantity stored in the storage 170 to determine whether or not an accident occurs. For example, the contact likelihood determiner 122 determines that an accident occurs when a matching degree of the feature quantity is equal to or greater than a threshold value.

When a determination is made that an accident is occurring in front of the host vehicle M, the contact likelihood determiner 122 determines whether or not the yaw angle of the other vehicle m1 is equal to or larger than a predetermined angle on the basis of the recognition result of the recognizer 110 (step S114). When the yaw angle of the other vehicle m1 is equal to or larger than the predetermined angle, the contact likelihood determiner 122 determines whether or not the number of consecutive confirmations is two (step S116). Under a situation in which a determination is made that an accident is occurring in the host vehicle M, there is a high likelihood that the other vehicle M is approaching the host vehicle M under some influence of the accident. Therefore, it is possible to determine the likelihood of contact more quickly and accurately by changing the number of confirmations in this case into a number of times smaller than the other number of times. In the processing of step S116, when a determination is made that the number of consecutive confirmations is not two, the processing returns to step S100.

When a determination is made in the processing of step S112 that an accident has not occurred in front of the host vehicle M, or when a determination is made in the processing of step S114 that the yaw angle of the other vehicle m1 is not equal to or greater than the predetermined angle, the contact likelihood determiner 122 determines whether or not the number of consecutive confirmations is four (step S118). When a determination is made that the number of consecutive determinations is not four, the processing returns to step S100.

When a determination is made in the processing of step S106, S110, S116, or S118 that the number of consecutive determinations is a designated number of times, the unavoidable contact determiner 124 determines whether or not the contact between the host vehicle M and the other vehicle m1 is unavoidable (step S120). When a determination is made that the contact is unavoidable, the operation controller 140 operates the occupant protection device 90 (step S122). When a determination is made that the contact is not unavoidable, the avoidance controller 150 controls one or both of the steering and speed of the host vehicle M to execute driving control for avoiding the contact between the host vehicle M and the other vehicle m1 (step S124). Thus, the processing of this flowchart ends. The processing of this flowchart ends when a determination is made in the processing of step S100 that there is no other vehicle m1 in front of the host vehicle M or when a determination is made in the processing of step S102 that the contact margin time TTC is not smaller than the threshold value (TTC<threshold value).

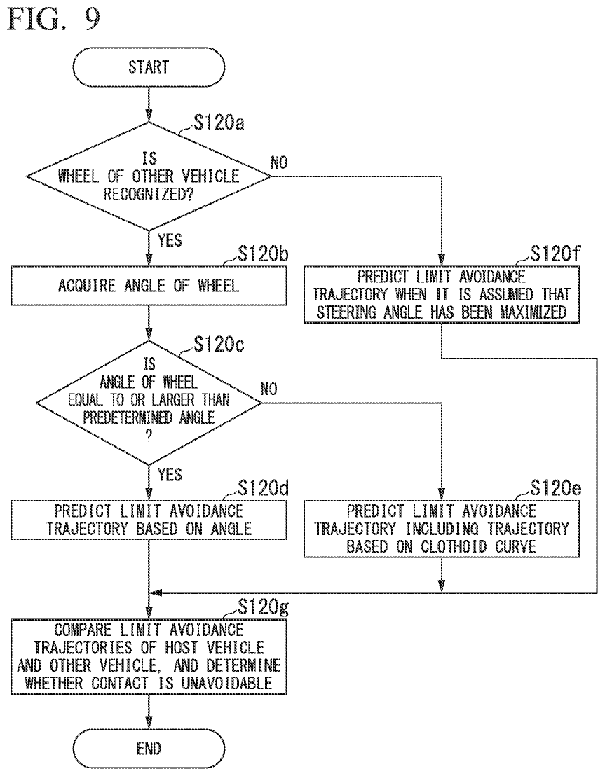

FIG. 9 is a flowchart illustrating an example of unavoidable contact determination processing. FIG. 9 illustrate, for example, details of the processing in step S120. In the example of FIG. 9, the unavoidable contact determiner 124 determines whether or not the wheel of the other vehicle m1 is recognized by the recognizer 110 (step S120a). When a determination is made that the wheel of the other vehicle m1 is recognized, the unavoidable contact determiner 124 acquires an angle of the recognized wheel (step S120b), and determines whether the acquired angle is equal to or larger than a predetermined angle (step S120c). When a determination is made that the angle of the wheel is equal to or greater than the predetermined angle, the unavoidable contact determiner 124 causes the trajectory predictor 130 to predict the limit avoidance trajectory on the basis of the angle of the wheel (step S120d). When a determination is made that the angle of the wheel is not equal to or greater than the predetermined angle, the unavoidable contact determiner 124 causes the trajectory predictor 130 to predict a limit avoidance trajectory including a trajectory based on the clothoid curve (step S120e). When a determination is made in step S120a that the wheel of the other vehicle m1 is not recognized, the unavoidable contact determiner 124 causes the trajectory predictor 130 to predict the limit avoidance trajectory when it is assumed that a steering angle (the orientation of the wheel) of the other vehicle m1 has been maximized (step S1201). After the processing of step S120d, S120e, or S120f, the unavoidable contact determiner 124 compares the limit avoidance trajectories of the host vehicle M and the other vehicle m1, and determines whether the contact is unavoidable (step S120g). Thus, the processing of this flowchart ends.

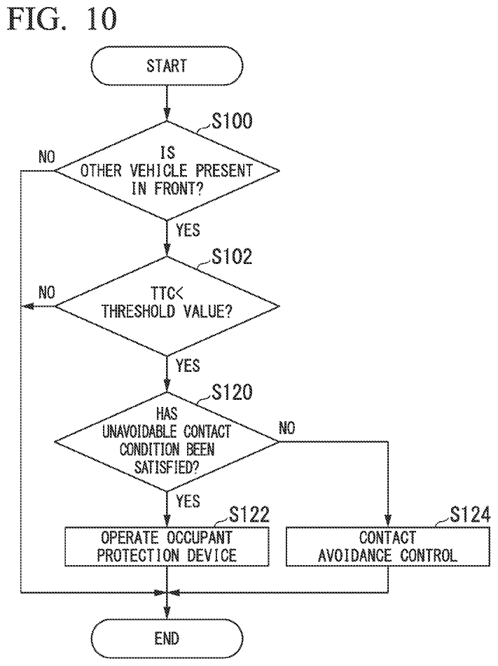

In the embodiment, at least part of the contact likelihood determination among the processing illustrated in FIG. 8 described above may be omitted. FIG. 10 is a flowchart illustrating another example of processing that is executed by the vehicle control device 100. In the example of FIG. 10, steps S104 to S118 among the processing of steps S100 to S124 illustrated in FIG. 8 are omitted. That is, in the process illustrated in FIG. 10, when a determination is made in the processing of step S102 that the contact margin time TTC between the host vehicle M and the other vehicle m1 is smaller than the threshold value, the unavoidable contact determination in the unavoidable contact determiner 124 is immediately executed. For the processing of step S120, for example, the processing illustrated in FIG. 9 described above may be executed. The processing illustrated in FIG. 8 and the processing illustrated in FIG. 10 may be switched depending on a travel situation of the host vehicle M and the processing may be performed. For example, when the host vehicle M or the other vehicle m1 is traveling on a general road or the like at a low speed (less than a predetermined speed), the processing illustrated in FIG. 8 is executed in consideration of a certain amount of spare time, and when the host vehicle M or the other vehicle m1 is traveling on an expressway or the like at a high speed (the predetermined speed or more), the processing illustrated in FIG. 10 is executed because there is no spare time. This makes it possible to perform the unavoidable contact determination more appropriately depending on a traveling situation, and operate the occupant protection device 90 more reliably before contact.

FIG. 11 is a flowchart illustrating an example of another processing of the unavoidable contact determination processing. The processing illustrated in FIG. 11 is executed, for example, at the time of the start of the processing of step S120 in FIGS. 8 and 10 described above, or before step S120a illustrated in FIG. 9. In the example of FIG. 11, the unavoidable contact determiner 124 determines whether or not a traffic participant (an example of an object) other than the other vehicle m1 (target object) that performs a determination as to whether contact is unavoidable is present within a forward viewing angle set by, for example, the angle of view of the camera 10 that images the forward side of the host vehicle M, on the basis of the recognition result of the recognizer 110 (step S200). Examples of the traffic participants here include a pedestrian, a bicycle, a two-wheeled vehicle, and a vehicle other than the other vehicle m1 that moves at a predetermined speed or more. A case in which the bicycle, the two-wheeled vehicle, or the vehicle other than the other vehicle m1 travels at a speed less than the predetermined speed (including stopping) may be included. When the pedestrian is moving, the amount of movement in a width direction (a horizontal direction) of the lane in which the host vehicle M is traveling may be used.

When a determination is made in the processing of step S200 that a traffic participant other than the other vehicle m1 is not present within the forward viewing angle of the camera 10, the unavoidable contact determiner 124 determines whether or not the traffic participant is not present in a predetermined range on both sides in the traveling direction of the traveling lane (step S202). “Within the processing distance on both sides” is, for example, a range of the vehicle width+several [m] in a direction away from the host vehicle M from a side end portion of the host vehicle M or demarcation lines of the traveling lane in a direction orthogonal to the forward direction of the host vehicle Ml. When a determination is made that the traffic participant is not present within the predetermined range on both the sides of the traveling lane, the unavoidable contact determiner 124 determines whether or not an object that causes a blind spot is present within the forward viewing angle (step S204). Examples of the object include obstacles such as a parked vehicle, a utility pole, a signboard, a plant, a wall, and a fence.

When a determination is made that the object that causes a blind spot is not present within the forward viewing angle, the unavoidable contact determiner 124 extracts a partial image area including the other vehicle m1 from the entire area of the camera image captured by the camera 10 (step S206). Next, the unavoidable contact determiner 124 increases a sampling rate for the partial image area recognized by the recognizer 110 (step S208), limits target recognition for performing tracking or the like to the other vehicle m1, and performs the determination as to whether the contact between the host vehicle M and the other vehicle m1 is unavoidable (step S210). Thus, this flowchart ends. Further, when a determination is made in the processing of step S200 that the traffic participant other than the other vehicle m1 is present within the forward viewing angle, when a determination is made in the processing of step S202 that the traffic participant is not present within the predetermined range on both the sides of the traveling lane of the host vehicle M, or when a determination is made in the processing of step S204 that an object that causes the blind spot is present within the forward viewing angle, the processing of this flowchart ends without extraction of the partial image area.

According to the above-described processing, when a predetermined condition (for example, a case in which visibility is good and a pedestrian is not present or is far away) is satisfied, a processing target image is set as a partial image, making it possible to reduce a processing load of external world recognition processing and realize high speed. Reducing the processing load makes it possible to make a recognition cycle of a target vehicle earlier and perform the unavoidable contact determination more quickly and accurately. Therefore, it is possible to secure time to protect the occupant and reduce a burden on the occupant due to contact with the other vehicle.

According to the embodiment described above, the vehicle control device 100 (an example of the mobile object control device) includes the recognizer 110 configured to recognize a surroundings situation of the host vehicle M (an example of the mobile object); and the unavoidable contact determiner 124 configured to determine whether or not contact between the host vehicle M and the object likely to come into contact with the host vehicle M is unavoidable on the basis of a recognition result of the recognizer 110 when there is the object around the host vehicle M, wherein the unavoidable contact determiner 124 limits the recognition range of the recognizer 110 to the predetermined range including the object when the recognition result of the recognizer 110 satisfies the predetermined condition, and determines whether or not the contact between the host vehicle M and the object is unavoidable, making it possible to perform more appropriate mobile object control since it is possible to make a processing timing of the unavoidable contact determination or the like earlier.

For example, according to the embodiment, when a predetermined condition is satisfied at the time of the unavoidable contact determination, the determination is performed using the partial image to temporarily stop recognition of white lines, pedestrians, or the like and limit the recognition processing to only surroundings of a target vehicle, making it possible to perform the determination processing quickly and in a short cycle according to processing performance According to the embodiment, when a future trajectory of another vehicle is predicted, a prediction method is changed on the basis of whether or not a traveling wheel of the other vehicle can be recognized, making it possible to perform a more accurate unavoidable contact determination, protect occupants without an excessive load, and suppress contact in a more advantageous situation. According to the embodiment, a condition for determining that there is a likelihood that the host vehicle M and the object will come into contact with each other in future is changed on the basis of the state of the object, and the likelihood that the host vehicle M and the object will come into contact with each other in future is determined on the basis of the changed condition, making it possible to improve the reliability of the unavoidable contact determination, and suppress an unnecessary operation of the occupant protection device 90 to appropriately operate the occupant protection device 90.

The embodiment described above can be expressed as follows.

A mobile object control device including

a storage device having a program stored therein, and

a hardware processor, and configured to

recognize a surroundings situation of a mobile object,

determine whether or not contact between the mobile object and an object likely to come into contact with the mobile object is unavoidable on the basis of a recognition result of the surroundings situation when there is the object around the mobile object; and

limit a recognition range to a predetermined range including the object when the recognition result satisfies a predetermined condition, and determine whether or not the contact between the mobile object and the object is unavoidable.

The mode for carrying out the present invention has been described above using the embodiments, but the present invention is not limited to such embodiments at all, and various modifications and replacements can be made without departing from the gist of the present invention.

What is claimed is:

1. A mobile object control device comprising:
a recognizer configured to recognize a surroundings situation of a mobile object; and
an unavoidable contact determiner configured to determine whether or not contact between the mobile object and an object likely to come into contact with the mobile object is unavoidable on the basis of a recognition result of the recognizer when there is the object around the mobile object,
wherein the unavoidable contact determiner limits a recognition range of the recognizer to a predetermined range including the object when the recognition result of the recognizer satisfies a predetermined condition, and determines whether or not the contact between the mobile object and the object is unavoidable.

2. The mobile object control device according to claim 1,
wherein the recognizer recognizes the surroundings situation of the mobile object from information including an image captured by an imager, and
the unavoidable contact determiner extracts a partial image including the object from the image when the recognition result of the recognizer satisfies the predetermined condition, and uses the extracted partial image to determine whether or not the contact between the mobile object and the object is unavoidable.

3. The mobile object control device according to claim 2, wherein a size of the partial image is set based on a relative distance between the mobile object and the object.

4. The mobile object control device according to claim 2, wherein the predetermined condition includes that there is no traffic participant other than the object within a forward viewing angle of the mobile object captured by the imager.

5. The mobile object control device according to claim 4, wherein the predetermined condition includes that there is no traffic participant within a predetermined range on both sides of a traveling lane of the mobile object, and that there is no object causing a blind spot for the mobile object within the forward viewing angle.

6. The mobile object control device according to claim 2, wherein the unavoidable contact determiner increases a sampling rate for the determination when determining whether or not the contact between the mobile object and the object is unavoidable using the partial image.

7. The mobile object control device according to claim 2, wherein, when the unavoidable contact determiner determines whether or not the contact between the mobile object and the object is unavoidable using the partial image, the unavoidable contact determiner makes a frame rate of the image captured by the imager higher than a frame rate before the unavoidable contact determination.

8. The mobile object control device according to claim 1, further comprising:
an operation controller configured to operate a protection device configured to protect an occupant of the mobile object when the unavoidable contact determiner determines that the contact between the mobile object and the object is unavoidable.

9. A mobile object control method comprising:
recognizing, by a computer, a surroundings situation of a mobile object;
determining, by the computer, whether or not contact between the mobile object and an object likely to come into contact with the mobile object is unavoidable on the basis of a recognition result of the surroundings situation when there is the object around the mobile object; and
limiting, by the computer, a recognition range to a predetermined range including the object when the recognition result satisfies a predetermined condition, and determining whether or not the contact between the mobile object and the object is unavoidable.

10. A computer-readable non-transitory storage medium having a program therein, the program causing a computer to:
recognize a surroundings situation of a mobile object;
determine whether or not contact between the mobile object and an object likely to come into contact with the mobile object is unavoidable on the basis of a recognition result of the surroundings situation when there is the object around the mobile object; and
limit a recognition range to a predetermined range including the object when the recognition result satisfies a predetermined condition, and determine whether or not the contact between the mobile object and the object is unavoidable.
